(19) United States
(12) Patent Application Publication
(10) Pub. No.: US 2011/0023069 A1
(43) Pub. Date: Jan. 27, 2011

(54) System and Method for Creating and Managing an Internet Protocol Television Personal Movie Library

(75) Inventor: John P. Dowens, Red Bank, NJ (US)

Correspondence Address: AT&T Legal Department - GMG;Attn: Patent Docketing, Room 2A-207, One AT&T Way, Bedminster, NJ, 07921, US

(73) Assignee: AT&T INTELLECTUAL PROPERTY I, L.P., Reno, NV (US)

(21) Appl. No.: 12/510,033

(22) Filed: Jul. 27, 2009

(51) Int. Cl. G06F 13/00; H04N 7/173

(52) U.S. Cl. 725/61; 725/92; 725/98

(57) ABSTRACT

A system and a method for creating and managing an Internet Protocol television personal movie library are disclosed. An access request for a movie library server and a personal movie library is received over a provider network. A movie search request for an on-demand movie is received over the provider network. The movie library server is searched for the on-demand movie. If the on-demand movie is located in the movie library server, then the on-demand movie is added to the personal movie library. If the on-demand movie is not located in the movie library server, then a content provider is connected to over a public network, the on-demand movie is downloaded from the content provider over the public network, and the on-demand movie is added to the personal movie library.

### FIELD OF THE DISCLOSURE

The present disclosure generally relates to communications networks, and more particularly relates to a system and method for creating and managing an Internet Protocol television personal movie library.

### BACKGROUND

Internet Protocol television (IPTV) service providers can offer users a variety of viewing options for different television programs and/or movies. For example, the IPTV service providers can supply users with real-time television programs that are typically available for the users to watch only at a specific date and time. The IPTV service providers can also offer the users on-demand movies that are available for an extended amount of time and that are provided to the users upon request of the on-demand movie.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a block diagram illustrating an Internet Protocol Television (IPTV) network in accordance with one embodiment of the present disclosure;

FIG. 2 is a block diagram of a portion of the IPTV network;

FIG. 3 is a flow diagram of a method for adding an on-demand movie to a personal movie library within the IPTV network;

FIG. 4 is a flow diagram of a method for managing the personal movie library; and

FIG. 5 is an illustrative embodiment of a general computer system.

The use of the same reference symbols in different drawings indicates similar or identical items.

### DETAILED DESCRIPTION OF THE DRAWINGS

The numerous innovative teachings of the present application will be described with particular reference to the presently preferred exemplary embodiments. However, it should be understood that this class of embodiments provides only a few examples of the many advantageous uses of the innovative teachings herein. In general, statements made in the specification of the present application do not necessarily delimit any of the various claimed inventions. Moreover, some statements may apply to some inventive features but not to others.

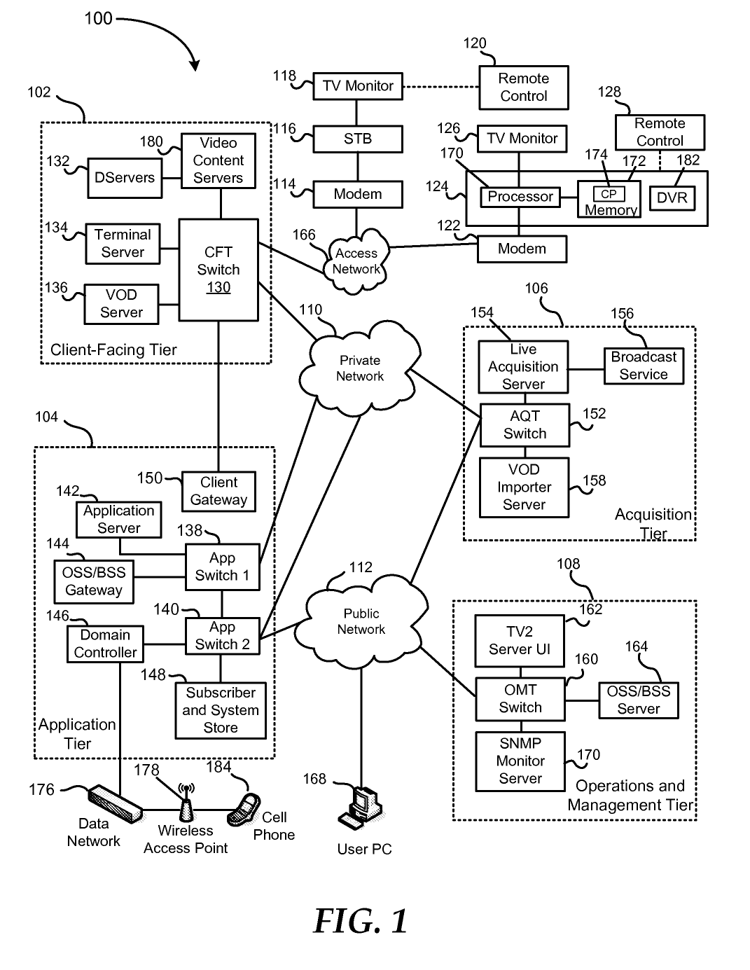

FIG. 1 shows an IPTV system 100 including a client facing tier 102, an application tier 104, an acquisition tier 106, and an operations and management tier 108. Each tier 102, 104, 106, and 108 is coupled to one or both of a private network 110 and a public network 112. For example, the client-facing tier 102 can be coupled to the private network 110, while the application tier 104 can be coupled to the private network 110 and to the public network 112 such as the Internet. The acquisition tier 106 can also be coupled to the private network 110 and to the public network 112. Moreover, the operations and management tier 108 can be coupled to the public network 112.

The various tiers 102, 104, 106, and 108 communicate with each other via the private network 110 and the public network 112. For instance, the client-facing tier 102 can communicate with the application tier 104 and the acquisition tier 106 via the private network 110. The application tier 104 can also communicate with the acquisition tier 106 via the private network 110. Further, the application tier 104 can communicate with the acquisition tier 106 and the operations and management tier 108 via the public network 112. Moreover, the acquisition tier 106 can communicate with the operations and management tier 108 via the public network 112. In a particular embodiment, elements of the application tier 104 can communicate directly with the client-facing tier 102.

The client-facing tier 102 can communicate with user equipment via a private access network 166, such as an Internet Protocol Television (IPTV) network. In an illustrative embodiment, modems such as a first modem 114 and a second modem 122 can be coupled to the private access network 166. The client-facing tier 102 can communicate with a first representative set-top box device 116 via the first modem 114 and with a second representative set-top box device 124 via the second modem 122. The client-facing tier 102 can communicate with a large number of set-top boxes over a wide geographic area, such as a regional area, a metropolitan area, a viewing area, or any other suitable geographic area that can be supported by networking the client-facing tier 102 to numerous set-top box devices. In one embodiment, the client-facing tier 102 can be coupled to the modems 114 and 122 via fiber optic cables. Alternatively, the modems 114 and 122 can be digital subscriber line (DSL) modems that are coupled to one or more network nodes via twisted pairs, and the client-facing tier 102 can be coupled to the network nodes via fiber-optic cables. Each set-top box device 116 and 124 can process data received from the private access network 166 via an IPTV software platform such as Microsoft® TV IPTV Edition.

The first set-top box device 116 can be coupled to a first display device 118, such as a first television monitor, and the second set-top box device 124 can be coupled to a second display device 126, such as a second television monitor. Moreover, the first set-top box device 116 can communicate with a first remote control 120, and the second set-top box device 124 can communicate with a second remote control 128. In an exemplary, non-limiting embodiment, each set-top box device 116 and 124 can receive data or video from the client-facing tier 102 via the private access network 166 and render or display the data or video at the display device 118 or 126 to which it is coupled. The set-top box devices 116 and 124 thus may include tuners that receive and decode television programming information for transmission to the display devices 118 and 126. Further, the set-top box devices 116 and 124 can include a set-top box processor 170 and a set-top box memory device 172 that is accessible to the set-top box processor. In a particular embodiment, the set-top box devices 116 and 124 can also communicate commands received from the remote controls 120 and 128 back to the client-facing tier 102 via the private access network 166.

In an illustrative embodiment, the client-facing tier 102 can include a client-facing tier (CFT) switch 130 that manages communication between the client-facing tier 102 and the private access network 166 and between the client-facing tier 102 and the private network 110. As shown, the CFT switch 130 is coupled to one or more data servers 132 that store data transmitted in response to user requests, such as video-on-demand material. The CFT switch 130 can also be coupled to a terminal server 134 that provides terminal devices, such as a game application server and other devices with a common connection point to the private network 110. In a particular embodiment, the CFT switch 130 can also be coupled to a video-on-demand (VOD) server 136.

The application tier 104 can communicate with both the private network 110 and the public network 112. In this embodiment, the application tier 104 can include a first application tier (APP) switch 138 and a second APP switch 140. In a particular embodiment, the first APP switch 138 can be coupled to the second APP switch 140. The first APP switch 138 can be coupled to an application server 142 and to an operation systems and support/billing systems and support (OSS/BSS) gateway 144. The application server 142 provides applications to the set-top box devices 116 and 124 via the private access network 166, so the set-top box devices 116 and 124 can provide functions such as display, messaging, processing of IPTV data and VOD material. In a particular embodiment, the OSS/BSS gateway 144 includes OSS data, as well as BSS data.

The second APP switch 140 can be coupled to a domain controller 146 that provides web access, for example, to users via the public network 112. The second APP switch 140 can be coupled to a subscriber and system store 148 that includes account information, such as account information that is associated with users who access the system 100 via the private network 110 or the public network 112. In a particular embodiment, the application tier 104 can also include a client gateway 150 that communicates data directly to the client-facing tier 102. In this embodiment, the client gateway 150 can be coupled directly to the CFT switch 130. The client gateway 150 can provide user access to the private network 110 and the tiers coupled thereto.

In a particular embodiment, the set-top box devices 116 and 124 can access the system via the private access network 166 using information received from the client gateway 150. The private access network 166 provides security for the private network 110. User devices can access the client gateway 150 via the private access network 166, and the client gateway 150 can allow such devices to access the private network 110 once the devices are authenticated or verified. Similarly, the client gateway 150 can prevent unauthorized devices, such as hacker computers or stolen set-top box devices, from accessing the private network 110 by denying access to these devices beyond the private access network 166.

For example, when the set-top box device 116 accesses the system 100 via the private access network 166, the client gateway 150 can verify subscriber information by communicating with the subscriber and system store 148 via the private network 110, the first APP switch 138 and the second APP switch 140. Further, the client gateway 150 can verify billing information and status by communicating with the OSS/BSS gateway 144 via the private network 110 and the first APP switch 138. The OSS/BSS gateway 144 can transmit a query across the first APP switch 138, to the second APP switch 140, and the second APP switch 140 can communicate the query across the public network 112 to the OSS/BSS server 164. After the client gateway 150 confirms subscriber and/or billing information, the client gateway 150 can allow the first set-top box device 116 access to IPTV content and VOD content. If the client gateway 150 cannot verify subscriber information for the first set-top box device 116, such as because it is connected to a different twisted pair, the client gateway 150 can deny transmissions to and from the first set-top box device 116 beyond the private access network 166.

The acquisition tier 106 includes an acquisition tier (AQT) switch 152 that communicates with the private network 110. The AQT switch 152 can also communicate with the operations and management tier 108 via the public network 112. In a particular embodiment, the AQT switch 152 can be coupled to a live acquisition server 154 that receives television content, for example, from a broadcast service 156. Further, the AQT switch can be coupled to a video-on-demand importer server 158 that stores television content received at the acquisition tier 106 and communicate the stored content to the client-facing tier 102 via the private network 110.

The operations and management tier 108 can include an operations and management tier (OMT) switch 160 that conducts communication between the operations and management tier 108 and the public network 112. In the illustrated embodiment, the OMT switch 160 is coupled to a TV2 server 162. Additionally, the OMT switch 160 can be coupled to an OSS/BSS server 164 and to a simple network management protocol (SNMP) monitor 166 that monitors network devices. In a particular embodiment, the OMT switch 160 can communicate with the AQT switch 152 via the public network 112.

In a particular embodiment during operation of the IPTV system, the live acquisition server 154 can acquire television content from the broadcast service 156. The live acquisition server 154 in turn can transmit the television content to the AQT switch 152 and the AQT switch can transmit the television content to the CFT switch 130 via the private network 110. Further, the television content can be encoded at the D-servers 132, and the CFT switch 130 can communicate the television content to the modems 114 and 122 via the private access network 166. The set-top box devices 116 and 124 can receive the television content from the modems 114 and 122, decode the television content, and transmit the content to the display devices 118 and 126 according to commands from the remote control devices 120 and 128.

Additionally, at the acquisition tier 106, the VOD importer server 158 can receive content from one or more VOD sources outside the IPTV system 100, such as movie studios and programmers of non-live content. The VOD importer server 158 can transmit the VOD content to the AQT switch 152, and the AQT switch 152 in turn can communicate the material to the CFT switch 130 via the private network 110. The VOD content can be stored at one or more servers, such as the VOD server 136.

When a user issues a request for VOD content to the set-top box device 116 or 124, the request can be transmitted over the private access network 166 to the VOD server 136 via the CFT switch 130. Upon receiving such a request, the VOD server 136 can retrieve requested VOD content and transmit the content to the set-top box device 116 or 124 across the private access network 166 via the CFT switch 130. In an illustrative embodiment, the live acquisition server 154 can transmit the television content to the AQT switch 152, and the AQT switch 152 in turn can transmit the television content to the OMT switch 160 via the public network 112. In this embodiment, the OMT switch 160 can transmit the television content to the TV2 server 162 for display to users accessing the user interface at the TV2 server. For example, a user can access the TV2 server 162 using a personal computer (PC) 168 coupled to the public network 112.

The domain controller 146 communicates with the public network 112 via the second APP switch 140. Additionally, the domain controller 146 can communicate via the public network 112 with the PC 168. For example, the domain controller 146 can display a web portal via the public network 112 and allow users to access the web portal using the PC 168. Further, in an illustrative embodiment, the domain controller 146 can communicate with at least one wireless network access point 178 over a data network 176. In this embodiment, each wireless network access point 178 can communicate with user wireless devices such as a cellular telephone 184.

In a particular embodiment, the set-top box devices can include a set-top box computer program 174 that is embedded within the set-top box memory device 172. The set-top box computer program 174 can contain instructions to receive and execute at least one user television viewing preference that a user has entered by accessing an Internet user account via the domain controller 146. For example, the user can use the PC 168 to access a web portal maintained by the domain controller 146 via the Internet. The domain controller 146 can query the subscriber and system store 148 via the private network 110 for account information associated with the user. In a particular embodiment, the account information can associate the user's Internet account with the second set-top box device 124. For instance, in an illustrative embodiment, the account information can relate the user's account to the second set-top box device 124 by associating the user account with an IP address of the second set-top box device, with data relating to one or more twisted pairs connected with the second set-top box device, with data related to one or more fiber optic cables connected with the second set-top box device, with an alphanumeric identifier of the second set-top box device, with any other data that is suitable for associating second set-top box device with a user account, or with any combination of these.

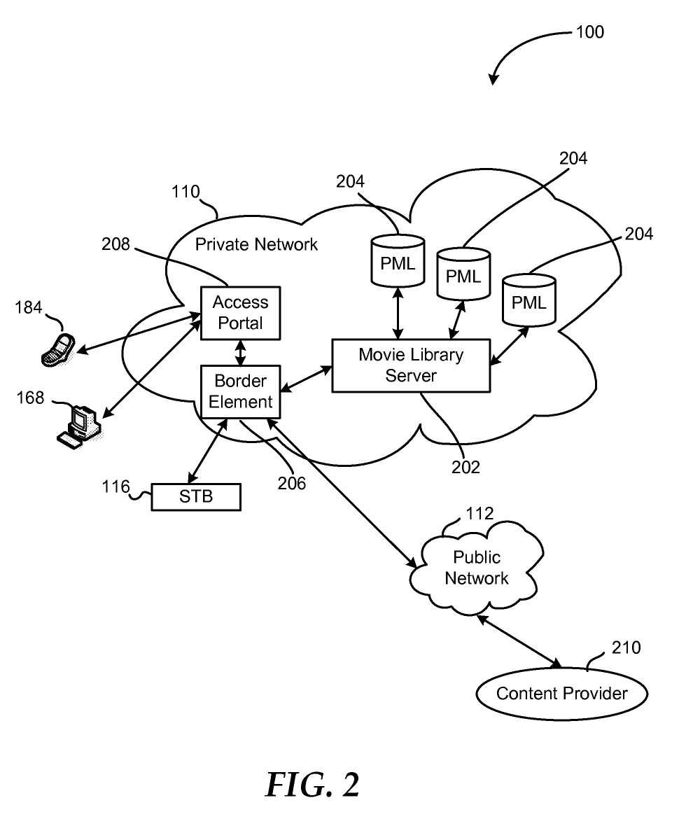

FIG. 2 shows a block diagram illustrating a portion of the IPTV system 100 including a movie library server 202, personal movie libraries 204, a border element 206, and an access portal 208. In an embodiment, the movie library server 202 can be the VOD server 136 of FIG. 1, the border element 206 can be the CFT switch 130 of FIG. 1, and the access portal 208 can be the domain controller 146 of FIG. 1. The movie library server 202, the personal movie libraries 204, the border element 206, and the access portal 208 are all preferably located within an IPTV provider network, such as the private network 110. The movie library server 202 is in communication with the personal movie libraries 204 and with the border element 206, which in turn is in communication with the access portal 208 and the set-top box device 116. In one embodiment, the border element 206 is also in communication with a content provider 210 via the public network 112. The access portal 208 is in communication with the PC 168 and the cellular telephone 184.

The movie library server 202 can store on-demand movies that can be offered to users of an IPTV service provider. In an embodiment, the movie library server 202 can include the personal movie libraries 204. In another embodiment, the personal movie libraries 204 can be external to the movie library server 202. Each personal movie library 204 can include a list of on-demand movies for a different user. The list of on-demand movies can be favorite on-demand movies of the user, specific on-demand movies that the user wants to watch, and the like.

A user can log onto the movie library server 202 by connecting to the access portal 208 via a client device, such as the PC 168 and/or the cellular telephone 184. The access portal 208 can authenticate the user prior to granting the user access to the private network 110 based on a username and password received from the PC 168 and/or the cellular telephone 184. Upon authenticating the user, the access portal 208 can connect the PC 168 and/or the cellular telephone 184 with the border element 206, which in turn can provide the PC and/or the cellular telephone with communication to the movie library server 202. If the user utilizes the set-top box device 116 to connect with the private network 110, the set-top box device can be directly connected to the border element 206 without having to be authenticated by the access portal 208. The border element 206 can authenticate the set-top box device 116 based on account information associated with the set-top box device.

Upon the user connecting with the movie library server 202, the user can create, manage, and/or view the personal movie library 204 associated with the user's account. If the user wants to add an on-demand movie to the personal movie library 204, the user can search the movie library server 202 for different on-demand movies. The user can search for an on-demand movie by entering different search terms, such as a movie title, an actor's name, a release year, keywords, and the like.

The movie library server 202 can then provide the user with a list of on-demand movies stored on the movie library server that meet the search terms entered by the user. The user can add on-demand movies to the personal movie library 204 by selecting one or more on-demand movies from the list, and the movie library server 202 can then add the selected movies to the personal movie library. The movie library server 202 can send a notification to the user indicating that the selected movies were added to the personal movie library 204. However, if the user does not find the on-demand movie that he is looking for in the list of on-demand movies stored in the movie library server 202, the user can elect to broaden the on-demand movie search to include other on-demand movie databases that may be located outside of the private network 110, such as an on-demand movie database of the content provider 210.

When a request to broaden the on-demand movie search beyond the private network 110 is received, the movie library server 202 can utilize the border element 206 to access the public network 112 and to connect to the content provider 210. The movie library server 202 can then perform the on-demand movie search, entered by the user, on the on-demand movie database of the content provider 210. If any on-demand movies available from the content provider 210 match the user's search terms, the movie library server 202 can present the user with a list of on-demand movies available from the content provider. If the user finds the movie that he is looking for, the user can select the on-demand movie for download from the content provider 210. The movie library server 202 can download the selected on-demand movie from the content provider 210, via the public network 112, and add the on-demand movie to the personal movie library 204 associated with the user. The movie library server 202 can send a notification to the user indicating that the on-demand movie was added to the personal movie library 204. The movie library server 202 can also store the on-demand movie, downloaded from the content provider 210, on the movie library server for later use by different users and different personal movie libraries.

If the user wants to watch an on-demand movie stored in the personal movie library 204, the user can access the personal movie library and request a list of movies stored in the personal movie library. The user can then select an on-demand movie to watch from the list of on-demand movies stored in the personal movie library 204. The movie library server 202 can send the selected on-demand movie to the client device that the user is currently using to access the personal movie library 204, such as the set-top box device 116, the PC 168, or the cellular telephone 184. The user can then watch the on-demand movie on the client device that has received the on-demand movie. However, while selecting an on-demand movie to watch, the user can also request that the movie library server 202 send the selected on-demand movie to a different client device other than the client device that the user is currently using to access the personal movie library 204. For example, the user can access the personal movie library 204 using the cellular telephone 184, can select an on-demand movie to watch from the personal movie library, and can request that the movie library server 202 send the selected on-demand movie to the set-top box device 116 and/or the PC 168.

The user can also permit other users to access the on-demand movies stored in the user's personal movie library 204. The other users that are granted permission to access the on-demand movies stored in the personal movie library 204 can select an on-demand movie to watch. However, these other users preferably may not be able to add on-demand movies to the personal movie library 204 and/or delete on-demand movies from the personal movie library. Thus, the user can provide other users of the movie library server 202 with the ability to watch the on-demand movies stored in his personal movie library 204 without granting them the ability to manipulate the on-demand movies in the personal movie library. In an embodiment, multiple users can have permission to access the personal movie library 204, and each of the users can watch the same on-demand movie at the same time.

Additionally, the user can upload movies to the movie library server 202 and the personal movie library 204. For example, if the user has a home movie stored on the PC 168, the user can connect to the movie library server 202 via the access portal 208 and the border element 206, can upload the home movie to the movie library server 202, and can add the home movie to the personal movie library 204 associated with the user. Upon the home movie being uploaded to the movie library server 202 and added to the personal movie library 204, the home movie can be provided as an on-demand movie to any user that has permission to watch the on-demand movies stored on the personal movie library. The movie library server 202 can also send a notification to the user indicating that the uploaded movie was added to the personal movie library 204.

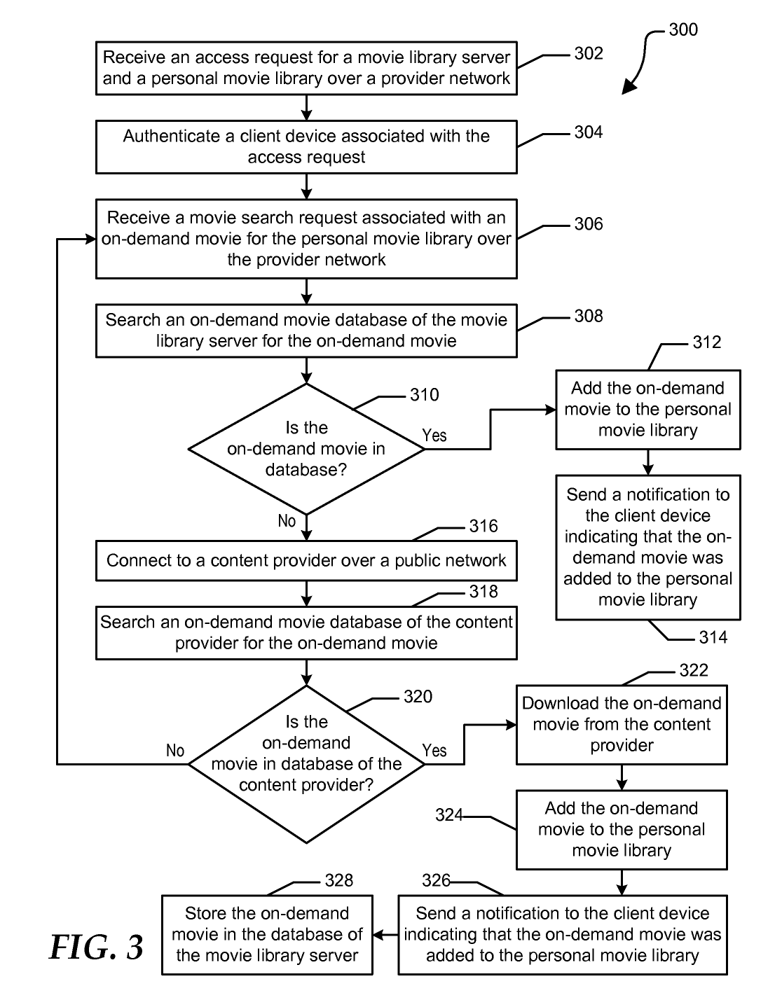

FIG. 3 is a flow diagram of a method 300 for adding an on-demand movie to a personal movie library within the IPTV network. At block 302, an access request for a movie library server and the personal movie library is received over a provider network. The access request can be received from a client device, such as a PC, a cellular telephone, and/or a set-top box device. The client device associated with the access request is authenticated at block 304. The authentication can be based on a type of client device used to access the personal movie library. For example, the set-top box device can be authenticated by a border element within the provider network based on account information associated with the set-top box device and stored within the provider network. The cellular telephone and PC can be authenticated by a user entering a username and password for an account, and the username and password being verified by an access portal within the provider network.

At block 306, an on-demand movie search request for an on-demand movie is received at the movie library server over the provider network. The on-demand movie search request can include a title of the movie, the release date of the movie, the production company for the movie, actors in the movie, and the like. An on-demand movie database of the movie library server is searched based on search terms of the on-demand movie search at block 308. At block 310, a determination is made whether the on-demand movie is stored within an on-demand movie database of the movie library server. If the on-demand movie is stored within the on-demand movie database, the on-demand movie is added to the personal movie library at block 312. At block 314, a notification is sent to the client device indicating that the on-demand movie was added to the personal movie library.

If the on-demand movie is not stored within the on-demand movie database, the movie library server is connected to a content provider over a public network at block 316. For example, the movie library server can be connected to the content provider over the public network via a border element within the provider network. Upon the movie library server connecting to the content provider, the on-demand movie search is performed on an on-demand movie database of the content provider at block 318. At block 320, a determination is made whether the on-demand movie is located in the on-demand movie database of the content provider. If the on-demand movie is not located in the on-demand movie database of the content provider, the flow diagram continues as stated above at block 306. If the on-demand movie is located in the on-demand movie database of the content provider, the on-demand movie is downloaded from the content provider to the movie library server at block 322. The on-demand movie is added to the personal movie library at block 324. At block 326, a notification is sent to the client device indicating that the on-demand movie was added to the personal movie library. The on-demand movie is stored in the database of the movie library server at block 328.

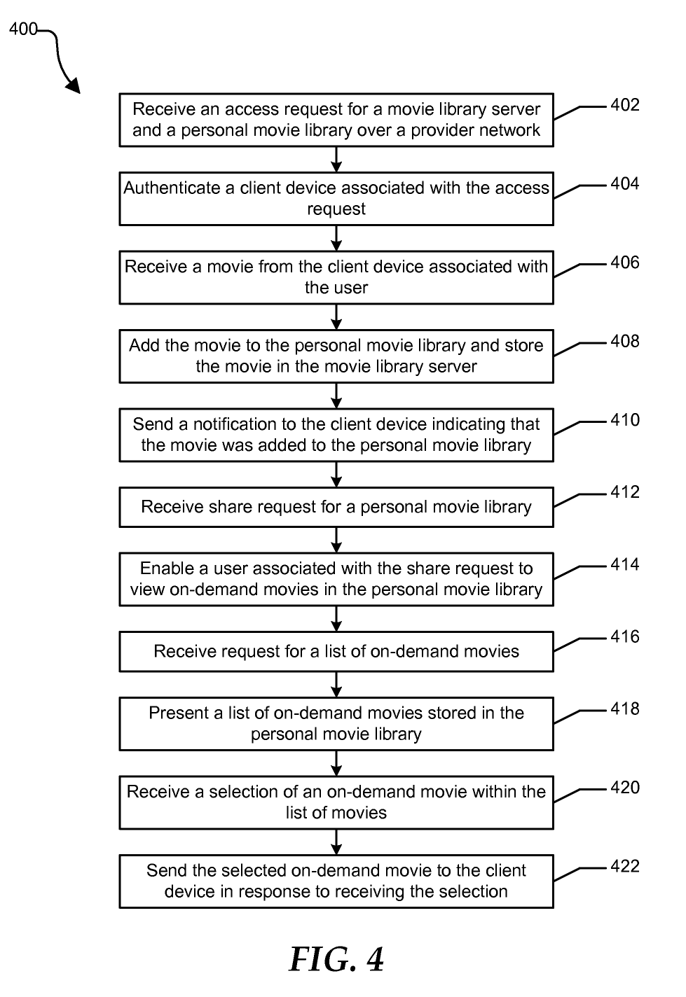

FIG. 4 is a flow diagram of a method 400 for managing a personal movie library within the IPTV network. At block 402, an access request for a movie library server and the personal movie library is received over a provide network. The access request can be received from a client device, such as a PC, a cellular telephone, and/or a set-top box device. The client device associated with the access request is authenticated at block 404. The authentication can be based on a type of client device used to access the personal movie library. For example, the set-top box device can be authenticated by a border element within the provider network based on account information associated with the set-top box device and stored within the provider network. The cellular telephone and PC can be authenticated by a user entering a username and password for an account, and the username and password being verified by an access portal within the provider network.

At block 406, a movie is received from the client device. The movie can be a home movie and/or any other video that the user sends to the movie library server. The movie is added to the personal movie library and stored in the movie library server at block 408. At block 410, a notification is sent to the client device indicating that the movie was added to the personal movie library. At block 412, a share request is received for the personal movie library. A user associated with the share request is enabled to view the on-demand movies in the personal movie library at block 414. At block 416, a list of on-demand movies request is received for the on-demand movies in the personal movie library. The list of on-demand movies stored in the personal movie library is presented at block 418. At block 420, a selection of an on-demand movie within the list of on-demand movies is received. The selected on-demand movie is sent to the client device in response to receiving the selection of the movie at block 422.

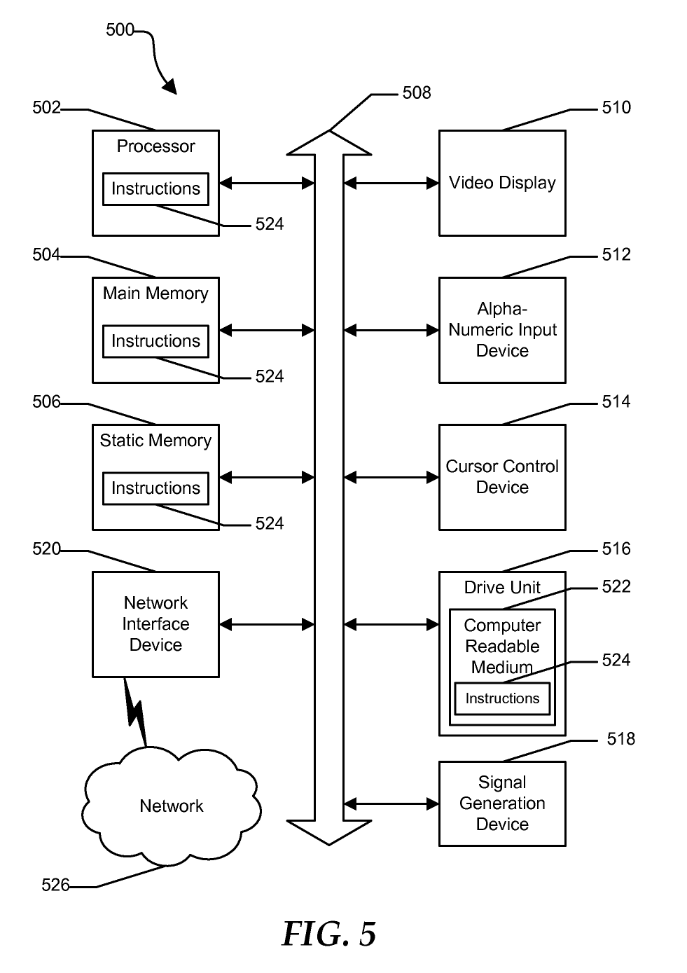

FIG. 5 shows an illustrative embodiment of a general computer system 500. The computer system 500 can include a set of instructions that can be executed to cause the computer system to perform any one or more of the methods or computer based functions disclosed herein. The computer system 500 may operate as a standalone device or may be connected, such as by using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 500 can also be implemented as or incorporated into various devices, such as a personal computer (PC), a tablet PC, an STB, a personal digital assistant (PDA), a cellular device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 500 can be implemented using electronic devices that provide voice, video or data communication. Further, while a single computer system 500 is illustrated, the term “system” shall also be taken to include any collection of systems or sub-systems that individually or jointly execute a set, or multiple sets, of instructions to perform one or more computer functions.

The computer system 500 may include a processor 502, such as a central processing unit (CPU), a graphics processing unit (GPU), or both. Moreover, the computer system 500 can include a main memory 504 and a static memory 506 that can communicate with each other via a bus 508. As shown, the computer system 500 may further include a video display unit 510 such as a liquid crystal display (LCD), an organic light emitting diode (OLED), a flat panel display, a solid state display, or a cathode ray tube (CRT). Additionally, the computer system 500 may include an input device 512 such as a keyboard, and a cursor control device 514 such as a mouse. The computer system 500 can also include a disk drive unit 516, a signal generation device 518 such as a speaker or remote control, and a network interface device 520 to communicate with a network 526. In a particular embodiment, the disk drive unit 516 may include a computer-readable medium 522 in which one or more sets of instructions 524, such as software, can be embedded. Further, the instructions 524 may embody one or more of the methods or logic as described herein. In a particular embodiment, the instructions 524 may reside completely, or at least partially, within the main memory 504, the static memory 506, and/or within the processor 502 during execution by the computer system 500. The main memory 504 and the processor 502 also may include computer-readable media.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the FIGs. are to be regarded as illustrative rather than restrictive.

The Abstract of the Disclosure is provided to comply with 37 C.F.R. §1.72(b) and is submitted with the understanding that it will not be used to interpret or limit the scope or meaning of the claims. In addition, in the foregoing Detailed Description of the Drawings, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description of the Drawings, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosed subject matter. Thus, to the maximum extent allowed by law, the scope of the present disclosed subject matter is to be determined by the broadest permissible interpretation of the following claims and their equivalents, and shall not be restricted or limited by the foregoing detailed description.

What is claimed is:

1. A device comprising:
a movie library server including:
a memory having a personal movie library; and
a processor configured to:
receive an access request for the movie library server and the personal movie library over a provider network;
receive a movie search request for an on-demand movie over the provider network;
search the movie library server for the on-demand movie; and
if the on-demand movie is located in the movie library server, then add the on-demand movie to the personal movie library; or
if the on-demand movie is not located in the movie library server, then connect to a content provider over a public network, download the on-demand movie from the content provider over the public network, and add the on-demand movie to the personal movie library.

2. The device of claim 1 wherein the processor is further configured to store the on-demand movie on the movie library server in response to downloading the on-demand movie from the content provider.

3. The device of claim 1 wherein the processor is further configured to receive a movie from a client device, and to add the movie from the client device to the personal movie library.

4. The device of claim 1 wherein the processor is further configured to receive a share request for the personal movie library, and to enable a user associated with the share request to access the personal movie library.

5. The device of claim 1 wherein the processor is further configured to present a list of on-demand movies stored in the personal movie library, to receive a selection of an on-demand movie within the list of movies, and to send the selected on-demand movie to a client device in response to receiving the selection.

6. The device of claim 5 wherein the selected on-demand movie in the list of on-demand movies is watched by multiple users at the same time.

7. The device of claim 1 wherein the processor is further configured to authenticate a client device to have access to the personal movie library in response to the access request.

8. A system comprising:
an access portal configured to provide a client device with access to a provider network;
a border element in communication with the access portal, the border element configured to provide communication between the client device and the provider network; and
a movie library server in communication with the border element, the movie library server including:
a memory having a personal movie library; and
a processor configured to:
receive an access request for the movie library server and the personal movie library;
receive a movie search request for an on-demand movie;
search the movie library server for the on-demand movie; and
if the on-demand movie is located in the movie library server, then add the on-demand movie to the personal movie library; or
if the on-demand movie is not located in the movie library server, then connect to a content provider over a public network, download the on-demand movie from the content provider over the public network, and add the on-demand movie to the personal movie library.

9. The system of claim 8 wherein the processor is further configured to store the on-demand movie on the movie library server in response to downloading the on-demand movie from the content provider.

10. The system of claim 8 wherein the processor is further configured to receive a movie from the client device, and to add the movie from the client device to the personal movie library.

11. The system of claim 8 wherein the processor is further configured to receive a share request for the personal movie library, and to enable a user associated with the share request to access the personal movie library.

12. The system of claim 8 wherein the processor is further configured to present a list of on-demand movies stored in the personal movie library, to receive a selection of an on-demand movie within the list of on-demand movies, and to send the selected on-demand movie to the client device in response to receiving the selection.

13. The system of claim 12 wherein the on-demand movie in the list of on-demand movies is watched by multiple users at the same time.

14. The system of claim 8 wherein the access portal is further configured to authenticate the client device to have access to the personal movie library in response to the access request.

15. A method comprising:
receiving an access request for a movie library server and a personal movie library over a provider network;
receiving a movie search request for an on-demand movie over the provider network;
searching the movie library server for the on-demand movie; and
if the on-demand movie is located in the movie library server, then adding the on-demand movie to the personal movie library; or
if the on-demand movie is not located in the movie library server, then connecting to a content provider over a public network, downloading the on-demand movie from the content provider over the public network, and adding the on-demand movie to the personal movie library.

16. The method of claim 15 further comprising:
storing the on-demand movie on the movie library server in response to downloading the on-demand movie from the content provider.

17. The method of claim 15 further comprising:
receiving a movie from a client device; and
adding the movie from the client device to the personal movie library.

18. The method of claim 15 further comprising:
receiving a share request for the personal movie library; and
enabling a user associated with the share request to view the personal movie library.

19. The method of claim 15 further comprising:
presenting a list of on-demand movies stored in the personal movie library;
receiving a selection of an on-demand movie within the list of on-demand movies; and
sending the selected on-demand movie to a client device in response to receiving the selection.

20. The method of claim 15 further comprising:
authenticating a client device to have access to the personal movie library in response to receiving the access request.
